(19) United States
(12) Patent Application Publication
(10) Pub. No.: US 2009/0260526 A1
(43) Pub. Date: Oct. 22, 2009

(54) GRILL RACK AND DRIP PAN

(76) Inventors: Jeffrey Anderson, St. Louis Park, MN (US); Matthew Fronk, Crystal, MN (US)

Correspondence Address: BRIGGS AND MORGAN P.A., 2200 IDS CENTER, 80 SOUTH 8TH ST, MINNEAPOLIS, MN, 55402, US

(21) Appl. No.: 12/420,257

(22) Filed: Apr. 8, 2009

Related U.S. Application Data
(60) Provisional application No. 61/123,480, filed on Apr. 9, 2008.

(51) Int. Cl. A47J 36/00

(52) U.S. Cl. 99/444

(57) ABSTRACT

A grill rack and drip pan, comprising a base, a support connected to the base for supporting grillable items; and a drip pan in operable communication with the support and base to channel drippings from the grillable items.

### CROSS-REFERENCE TO RELATED APPLICATION

The present application is based on and claims the benefit of U.S. provisional patent application Ser. No. 61/123,480, filed Apr. 9, 2008, the content of which is hereby incorporated by reference in its entirety.

### BACKGROUND OF THE INVENTION

Outdoor cooking, or barbecuing, using gas or charcoal grills is well-known and widely enjoyed. Popular grillable food items include poultry, such as breasts, thighs, wings and legs, pork ribs, various cuts of beef, vegetables such as sweet corn, and the like. Grilling turkeys is becoming increasingly popular, as is grilling lamb, and other meats, as well as grilling vegetables. Barbequed pork ribs are perhaps the most popular grillable summer fare. Nevertheless, chicken remains a favorite food for grilling. The popularity of grilled foods has also led to oven barbequing, particularly when outdoor cooking is not available.

When grilling, however, several complications arise. Typically, grillable items are generally laid horizontally on a grated grill surface, with heat rising from below. The grillable items cover a large portion of the grill surface area relative to the volume of the wings and legs, thus limiting the quantity of food items that can be cooked. Often the heat of the coals or even gas is unevenly distributed across the grill, and can result in some food items that are overcooked and others that are undercooked, or food items that are both. Avoidance of this problem requires frequent monitoring and movement, e.g. turning or repositioning the food during cooking; which can interfere with the scaring/cooking process.

With frequent movement of the grillable items, in the situation where the grill is covered, heat and smoke are lost whenever the grill lid or oven door are opened. Heat loss from repeatedly opening the lid or door lengthens the time needed for proper cooking. Raising the lid also exposes smoke to the eyes, plus the risk of burns or singes. The risk from smoke and flare-ups is greater when applying grilling sauce to the food items, where the fat content of the sauce increases the flammability of the resultant drippings.

Many grillable items, such as chicken wings, are relatively thin. Occasionally, one can fall between the grill wires/tines into the fire below. Also, portions of both wings and legs, e.g. wing tips and the “knuckle” end of legs, can fall between the grill spaces, lodge therein, and become charred. Other items are prone to separation as they cook, wherein again the smaller pieces can fall through the grill. Further, items have variable thicknesses of along their length. It is difficult to cook sufficiently the thick portion of meat without overcooking, drying, or burning the thinner portions.

Yet another very common problem with grilling result from the drippings of the grillable items falling into the fire, which can cause dramatic flare up. The fat rich drippings are highly flammable and not subject to dousing with water. The flare ups can lead to charred grillable items, and more seriously to burns to the cook, and even to the spread of hard to extinguish grease fires. Additionally, for other reasons the grillable items can be subject to direct contact with flames from the fire, which similarly causes charring or uneven cooking.

These and other problems are not only limited to outdoor barbeque grilling, but can occur with indoor range top grills and even in oven cooking.

Accordingly, a need exists for a grilling/cooking apparatus that reduces the foregoing dangers and drawbacks.

### BRIEF DESCRIPTION OF THE FIGURES

FIG. 1 a perspective view of a grill rack and drip pan.

FIG. 2 is a perspective view of the grill rack and drip pan in separated form.

FIG. 3 is a perspective view of the grill rack and drip pan in operational use.

FIG. 4 is a perspective view of the grill rack and drip pan in operational use.

FIG. 5 is a perspective view of the grill rack and drip pan in operational use.

FIG. 6 is a perspective view of the grill rack and drip pan in operational use.

FIG. 7 is a perspective view of an alternative grill rack and drip pan.

FIG. 8 is a perspective view of a further alternative of the grill rack and drip pan.

FIG. 9 is a perspective view of yet another alternative embodiment of the grill rack and drip pan.

### DETAILED DESCRIPTION OF THE PREFERRED EMBODIMENT

In the Figures is shown a combination grill rack and drip pan, which eliminates or substantially eliminates the problems of the prior art.

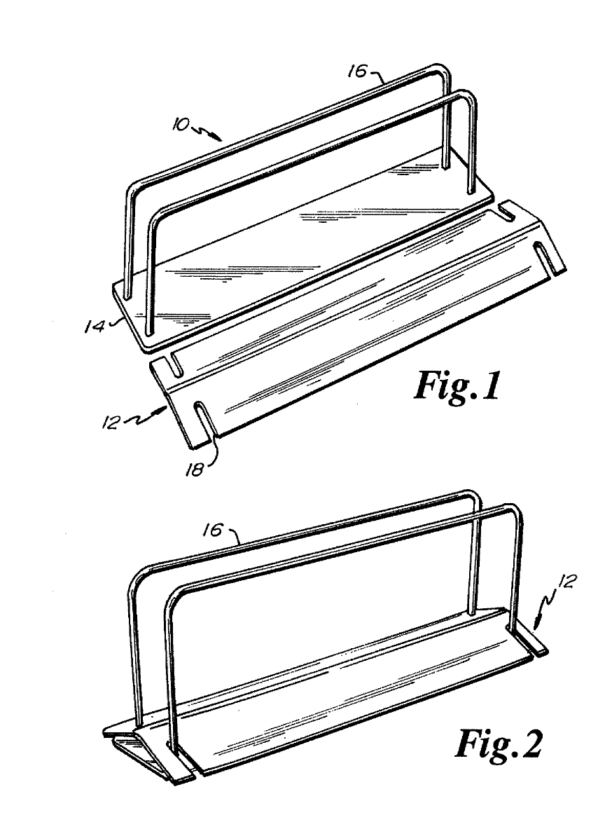

FIG. 1 shows the grill rack 10 and the drip pan 12 in separated form. The grill rack 10 includes a base 14, which is substantially rectangular and planer. Two parallel supports 16 extend upward from each end of the base 14 and along the longitudinal axis of the base 14. The supports 16 are spaced apart an appropriate width to receive the grillable items therebetween.

The drip pan 12 includes transverse notches 18 on both ends and sides, which allow the drip pan 12 to fit over supports 16, and drop downward to rest on the base 14. As shown in FIG. 2, the drip pan 12 is in the operational position and is held in place by the supports 16. The drip pan 12 has a camber or arched shaped to facilitate movement of the drippings away from the grillable items.

FIG. 1 shows the drip pan 12 separated from the grill rack 10. The drip pan 12 is easily removed and inserted due to the notches 18, which also allows for ease of use and cleaning.

FIG. 2 shows the drip pan 12 and grill rack 10 in combined operational form, wherein the drip pan 12 is fits over the supports 16 via the notches 18 to form a releasably secure engagement.

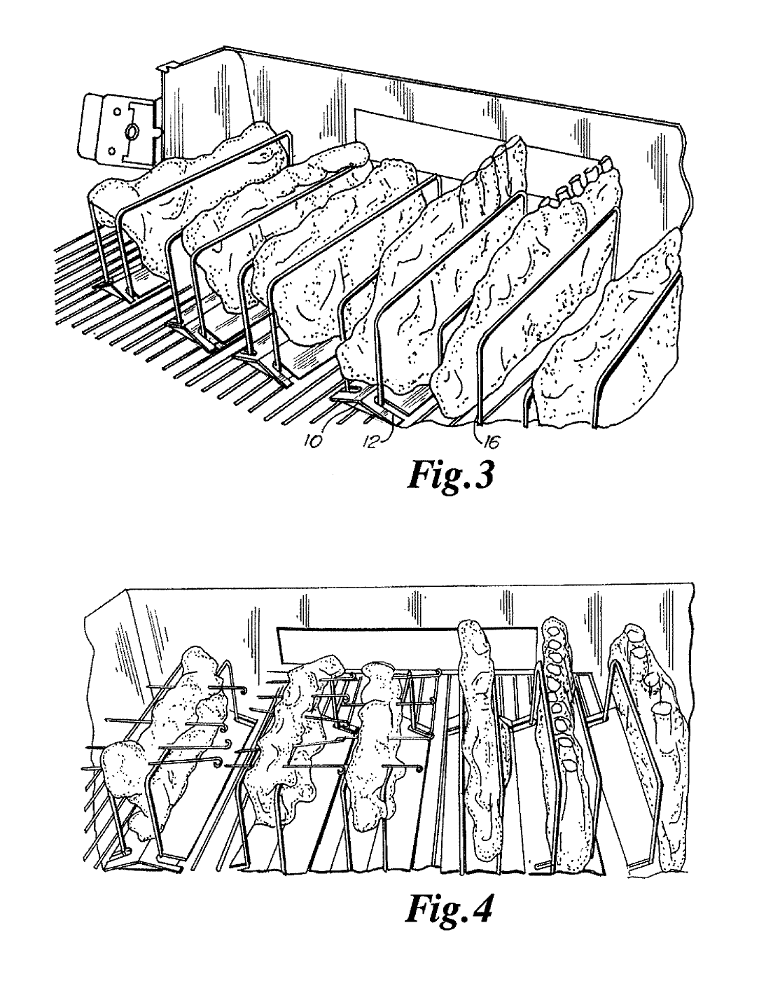

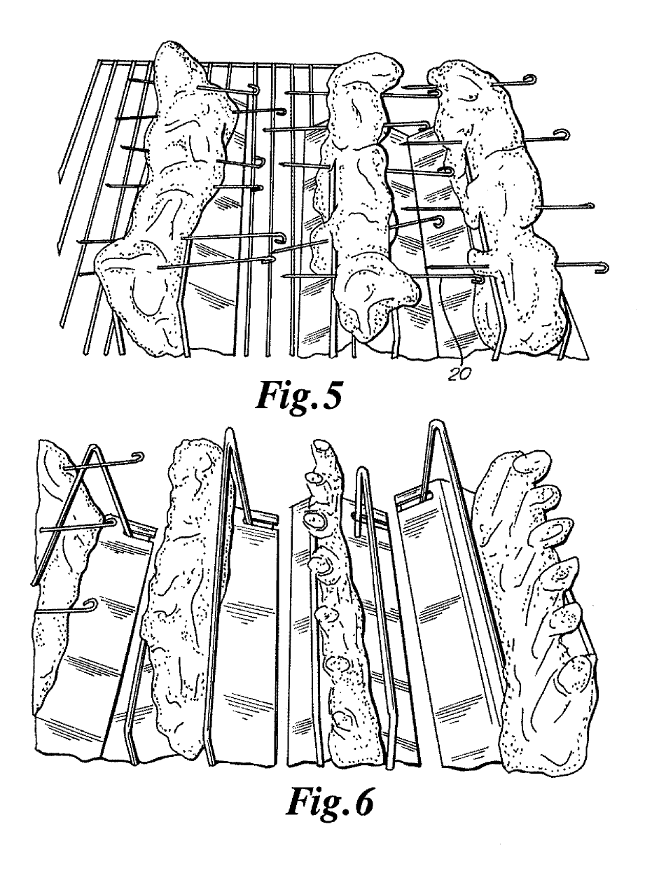

FIGS. 3-6 show the grill rack 10 and drip pan 12 in combination, and as used in cooking. In this case the grillable items are chicken and pork ribs. The grillable items fit between the supports 16, which are sized accordingly to hold the items in place during cooking. As shown in FIGS. 4 and 5, skewers 20 can be used to further hold and support the grillable in connection with the supports 16. This particularly helpful in the case of chicken pieces which tend to be irregularly shaped relative to the supports. The skewers 20 also assist with removal of the chicken when completely cooked. The grillable items are held securely in place and in a manner that will substantially reduce the likelihood of any portion of the grillable items falling through the grill.

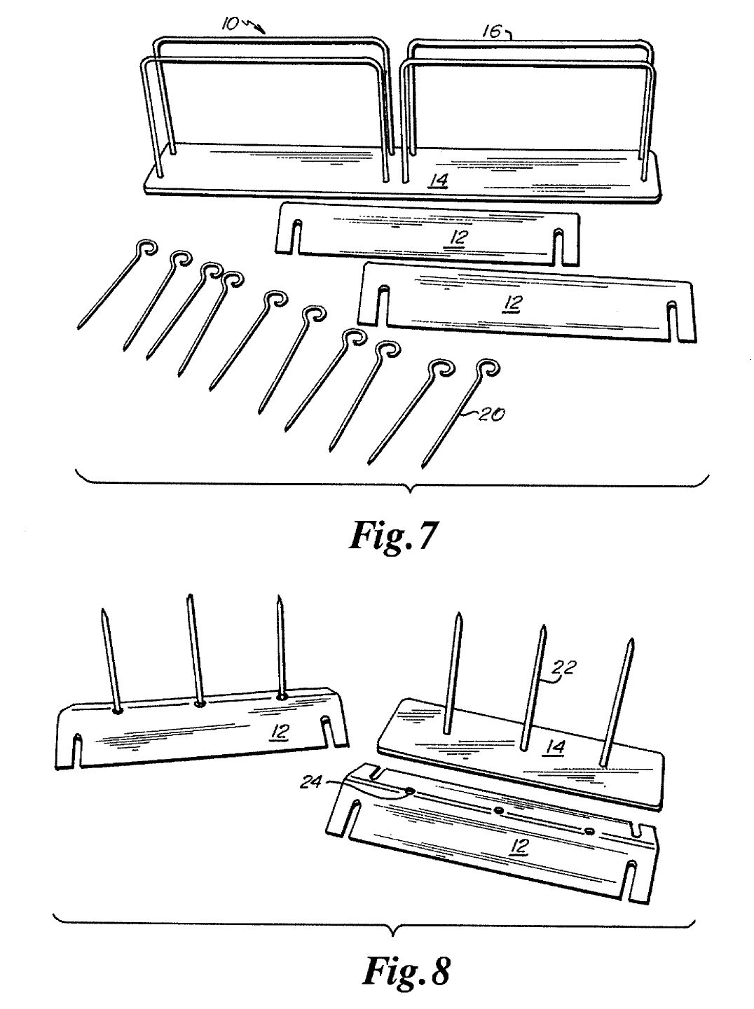

As can be seen in FIGS. 5-6, the combination of the base 14 and drip pan 12 along with the unique shape of the drip pan 12, effectively channel drippings, such as grease or sauce, down and to the side so that any flare ups resulting will not char the grillable items. In this manner, flames are prevented from directly contacting the grillable items, no matter the source or cause of the flare up, but heat is not prevented from effectively cooking the grillable items. Additionally, the grill rack 10 allows for easy placement and movement of the grillable items, if needed, and because of the engagement of the notches 18 in the drip pan 12 with the supports 16 the drip pan 12 moves together with the grill rack 10. Furthermore, the grill rack 10 and drip pan 12 are made of a heat conducting material, such as stainless steel, which promote uniform application of heat to the grillable items. Still further, the choice of material also aids clean up. Those of ordinary skill in the art will appreciate that other materials of a similar nature can and will be used, such as non-stick coatings and the like, and that the present invention is suitable for use with ovens as well as grills.

FIG. 7 shows an alternative embodiment of the present invention. The grill rack 10 is elongated to accommodate two parallel sets of supports 16. In accord therewith, two drip pans 12 are included. One for use with each set of supports 16. This embodiment is particularly useful with longer grills. A plurality of skewers 20 is also provided for use as disclosed hereinabove.

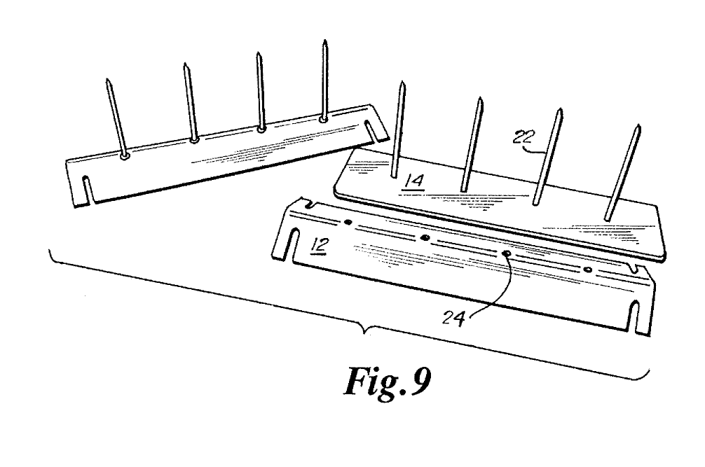

FIG. 8 shows another alternative embodiment of the present invention. The grill rack 10 includes a plurality of spikes 22 for supports. The grillable items are placed on the spikes, which otherwise function substantially the same as the parallel rails support of the previously disclosed embodiments. The drip pans 12 include a plurality of holes 24 aligned with the spikes 22 to allow the drip pan 12 to releasably secure to the grill rack 10 in the manner described herein above. FIG. 9 shows an embodiment of the present invention similar to that disclosed in FIG. 8, however, with additional spikes 22 and corresponding holes 24.

In the foregoing manner the present invention substantially overcomes the limitation so of the prior art.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods, and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention.

1. A grill rack and drip pan, comprising:
(a) a base;
(b) a support connected to said base for supporting grillable items; and
(c) a drip pan in operable communication with said support and base to channel drippings from the grillable items.

2. The grill rack and drip pan of claim 1 wherein the support comprises a set of rails.

3. The grill rack and drip pan of claim 2 wherein the rails comprise two parallel rails.

4. The grill rack and drip pan of claim 1 wherein the drip pan comprises slots aligned with the support to allow for releasable engagement therewith.

5. The grill rack and drip pan of claim 1 further comprising skewers adapted to secure the grillable items.

6. The grill rack and drip pan of claim 1 wherein the support comprises a spike.

7. The grill rack and drip pan of claim 6 wherein the support comprises a plurality of spikes.

8. The grill rack and drip pan of claim 7 wherein the drip pan comprises holes aligned with said spikes.

9. The grill rack and drip pan of claim 1 comprising two supports connected to the base.

10. The grill rack and drip pan of claim 9 wherein each support comprises a set of two parallel rails.
